(19) United States
(12) Patent Application Publication
(10) Pub. No.: US 2025/0121450 A1
(43) Pub. Date: Apr. 17, 2025

(54) WELDING METHOD

(71) Applicant: Hitachi Astemo, Ltd., Hitachinaka-shi, Ibaraki (JP)

(72) Inventors: Jeremy JONG, Hitachinaka-shi, Ibaraki (JP); Toshio HORI, Hitachinaka-shi, Ibaraki (JP)

(73) Assignee: Hitachi Astemo, Ltd., Hitachinaka-shi, Ibaraki (JP)

(21) Appl. No.: 18/721,552

(22) PCT Filed: Dec. 21, 2021
(86) PCT No.: PCT/JP2021/047321

§ 371 Date: Jun. 18, 2024

(51) Int. Cl. B23K 9/16

(52) U.S. Cl. CPC B23K 9/16

(57) ABSTRACT

Provided is a welding method of preventing specular reflection when a surface of a welding target material is photographed and suppressing an occurrence of porosity of the welding target material.

According to the present invention, a welding method includes melting steps (a) and (b) of melting a bonding portion of a welding target material 1 by arc discharge 4 while blowing an inert gas 3 to the bonding portion, and an oxidation step (d) of oxidizing the bonding portion by supplying the inert gas and a gas 6 containing oxygen to the bonding portion in a state where a portion of the melted bonding portion 7 is solidified and the other portion is melted.

### TECHNICAL FIELD

The present invention relates to a welding method.

### BACKGROUND ART

Gas shielded arc welding, which is a type of welding method, is arc welding in which welding is performed while a welding surface of a welding target material is shielded from air by an inert gas. That is, since the welding target material heated and melted by a welding power supply is activated and oxidation is not caused by oxygen in the atmosphere, bonding is performed while injecting an impermissible gas to the welding target material.

As an example of a conventional arc welding technique, for example, there is PTL 1. PTL 1 discloses a consumable electrode type gas shielded arc welding method of arc-welding two steel sheets by using a welding torch having a consumable electrode. The consumable electrode type gas shielded arc welding method includes performing arc welding while supplying a shielding gas in which an oxygen potential α represented by a predetermined expression is 1.5% to 5% from the welding torch toward the consumable electrode, and blowing an oxidation promoting gas in which an oxygen potential β represented by another predetermined expression is 15% to 50%, to a welding bead and a welding stop end portion formed by the arc welding in a state of 700° C. or higher, at a flow rate of 1 to 3 m/sec.

In PTL 1 disclosed above, the oxidation promoting gas is intentionally blown to a welding surface of a welding target material. That is, the surfaces of the welding bead and the welding stop end portion formed by arc welding in the state of 700° C. or higher are exposed to the oxidation promoting gas having a high oxygen potential B. Thus, the surfaces of the welding bead and the welding bead stop end can be covered with conductive iron oxide slag, and thus insulating Si, Mn-based slag does not appear on the surfaces. Therefore, even when a structural member including a welded portion is subjected to electrodeposition coating, electrodeposition coating defects do not occur in the welded portion, and therefore corrosion resistance of the structural member can be enhanced.

### CITATION LIST

### Patent Literature

PTL 1: WO 2017/126657 A

### SUMMARY OF INVENTION

### Technical Problem

In the conventional gas shielded arc welding method, an inert gas is blown to the surface of a conductor. Thus, the surface of the conductor is not oxidized, has glossiness, and specularly reflects light rays of surrounding objects like a mirror. Therefore, there is a problem that it is difficult to image the surface and boundary information of the conductor by an optical system such as a camera. In addition, in shape measurement by a laser line distance sensor, the reflected light from the glossy surface is not diffusely reflected, so that the amount of received reflected light is decreased and measurement accuracy is decreased.

As a means for controlling the appearance glossiness of the conductor, there is a method of reducing the amount of inert gas during heating and melting and intentionally oxidizing the conductor, but such a method has a problem that mechanical characteristics are deteriorated due to solidification defects of porosity.

In PTL 1 disclosed above, the oxidation promoting gas is blown during welding, but in such a method, the shielding gas is disturbed, and voids occur in the welding target material. Thus, there is a concern that mechanical characteristics are deteriorated.

In view of the above circumstances, an object of the present invention is to provide a welding method of preventing specular reflection when a surface of a welding target material is photographed and suppressing an occurrence of porosity of the welding target material.

### Solution to Problem

To achieve the above object, according to an aspect of the present invention, a welding method includes a melting step of melting a bonding portion of a welding target material by arc discharge while blowing an inert gas to the bonding portion, and an oxidation step of oxidizing the bonding portion by supplying the inert gas and a gas containing oxygen to the bonding portion in a state where a portion of the melted bonding portion 7 is solidified and the other portion is melted.

A more specific configuration of the present invention is described in the claims.

### Advantageous Effects of Invention

According to the present invention, it is possible to provide a welding method of preventing specular reflection when a surface of a welding target material is photographed and suppressing an occurrence of porosity of the welding target material.

Problems, configurations, and effects other than those described above clarified by the following description of embodiments.

### BRIEF DESCRIPTION OF DRAWINGS

FIG. 1 is a cross-sectional view and a graph showing an example of a flow of a welding method according to the present invention.

FIG. 2 is a cross-sectional view and a graph showing an example of a flow of a conventional welding method.

FIG. 3 is a graph showing results of a depth direction analysis of oxygen atom densities of surfaces of a welding material produced by the welding method in the present invention and a welding material produced by the conventional welding method.

FIG. 4 is a picture showing photographing results of the welding material produced by the welding method in the present invention and the welding material produced by the conventional welding method with a 2D camera and photographing results of the welding material produced by the welding method in the present invention and the welding material produced by the conventional welding method with a laser measuring instrument.

FIG. 5A is a perspective view showing a first example of an oxygen supply device used in the welding method in the present invention.

FIG. 5B is a perspective view showing the first example of the oxygen supply device used in the welding method in the present invention.

FIG. 5C is a top view and a side view showing the first example of the oxygen supply device used in the welding method in the present invention.

FIG. 6 is a top view and a side view showing a second example of an oxygen injection device used in the welding method in the present invention.

### DESCRIPTION OF EMBODIMENTS

Hereinafter, a welding method according to the present invention will be described with reference to the drawings.

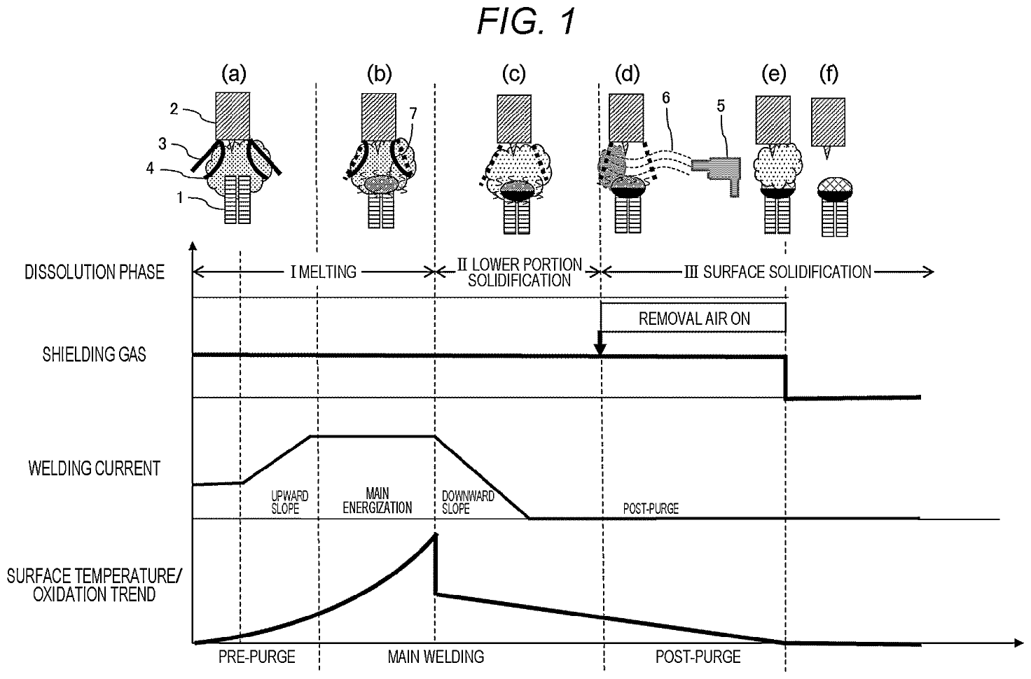

FIG. 1 is a cross-sectional view and a graph showing an example of a flow of the welding method in the present invention. FIG. 1 shows flows (a) to (f) of the welding method in the present invention together with schematic cross-sectional views of a welding target material 1, a welding torch 2, a shielding gas 3, an arc 4, an oxygen supply device 5, an oxygen-containing gas 6, and a bonding portion 7, and further shows graphs of a dissolution phase, a shielding gas flow rate, a welding current, and a surface temperature in each of the steps (a) to (f).

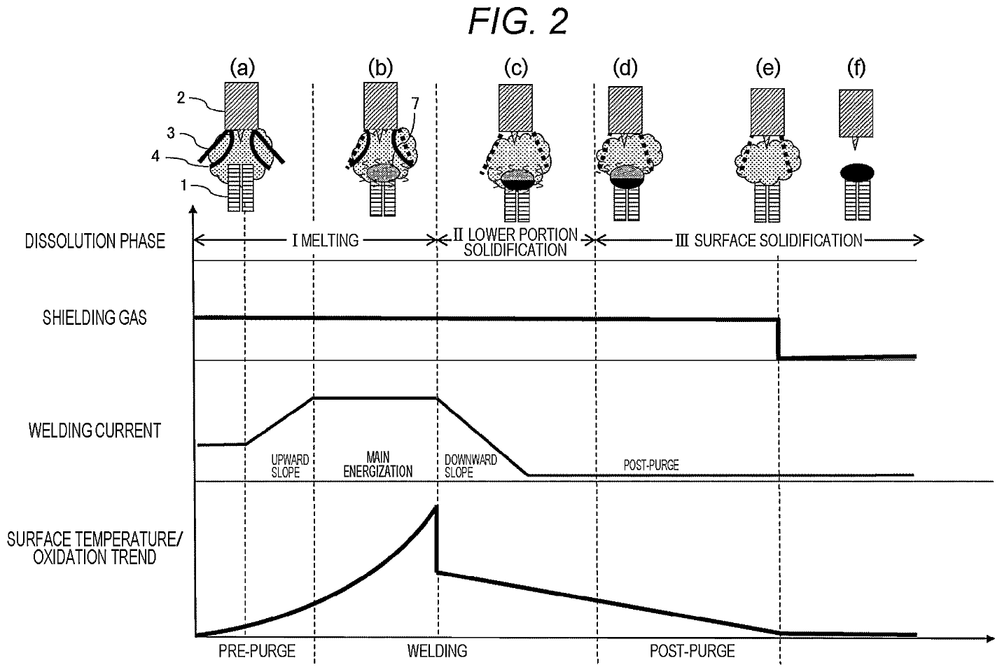

As shown in FIG. 1, a welding method according to the present invention includes melting steps (a) and (b) of melting a bonding portion of a welding target material 1 by arc discharge 4 while blowing an inert gas (shielding gas) 3 to the bonding portion, and an oxidation step (d) of oxidizing the bonding portion by supplying a gas 6 containing oxygen to the inert gas 3 and the bonding portion 7 in a state where a portion of the melted bonding portion 7 is solidified and the other portion is melted. As a comparison with FIG. 1, FIG. 2 shows a cross-sectional view and a graph showing an example of a flow of a conventional welding method.

In the present invention, as shown in FIG. 1, two welding target materials (conductors) 1 are installed, and tips thereof are brought into contact with each other and fused by control of an arc (heat source) 4 to obtain a bonding portion (molten portion) 7. At this time, the bonding portion 7 is solidified from the lower portion toward the upper portion (surface), but, in a state where the surface is molten, that is, during a period in which the solidification of the surface is not ended, the gas 6 containing oxygen is blown to the inert gas 3 and the bonding portion 7 to oxidize the surface of the bonding portion 7.

As described above, by injecting the oxygen-containing gas to the surface of the bonding portion 7, the inert gas 3 remaining around the bonding portion 7 is removed, and the surface of the bonding portion 7 is intentionally oxidized, whereby it is possible to reduce glossiness of the surface of the bonding portion 7 and to prevent specular reflection at the time of photographing.

Further, in the present invention, oxygen is introduced in a solidification process of the bonding portion 7 after the welding is ended, unlike a case where oxygen is introduced during welding. Thus, porosity inside the welding target material 1 does not occur and there is no concern that the mechanical properties of the welding target material 1 are deteriorated.

Since the present invention is configured to remove the inert gas 3 by injecting the oxygen-containing gas 6 to the inert gas 3, there is no need to stop the supply of the inert gas 3. Therefore, the electrode of the welding torch 2 can also be stored.

An oxygen supply step is preferably performed when the temperature of the surface of the bonding portion 7 of the welding target material 1 is 400° C. or higher. When the temperature of the surface of the bonding portion 7 of the welding target material 1 is lower than 400° C., it is not possible to efficiently oxidize the surface of the bonding portion 7 of the welding target material 1.

The oxygen-containing gas 6 is not particularly limited as long as the gas contains oxygen, and it is convenient to use air. In addition, the oxygen supply device 5 is not particularly limited, and may have any form as long as the oxygen supply device 5 can efficiently supply the oxygen-containing gas 6 to the surface of the bonding portion 7.

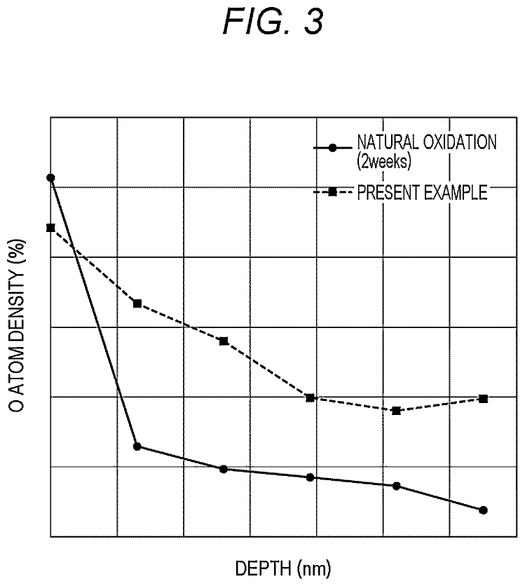

FIG. 3 is a graph showing results of a depth direction analysis of oxygen atom densities of surfaces of a welding material produced by the welding method in the present invention and a welding target material produced by the conventional welding method. As shown in FIG. 3, according to the method in the present invention shown in FIG. 1, it can be seen that the oxygen concentration of the surface of the welding target material is higher than that of the welding target material in the conventional method. It can be seen that, although the surface of the welding target material is naturally oxidized to some extent, the oxygen concentration is much higher in the case of performing the oxygen supply step as in the present invention than in the case of natural oxidation. Note that the concentration of oxygen atoms on the surface can be analyzed by a scanning electron microscope (SEM) or an electron spectroscopy for chemical analysis (ESCA).

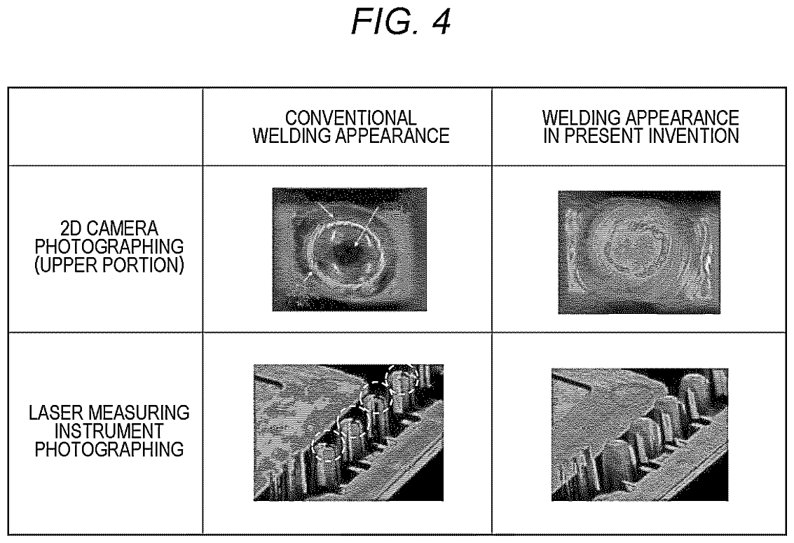

FIG. 4 is a picture showing photographing results of the welding material produced by the welding method in the present invention and the welding material produced by the conventional welding method with a 2D camera and photographing results of the welding material produced by the welding method in the present invention and the welding material produced by the conventional welding method with a laser measuring instrument. As shown in results of performing photographing with a 2D camera in FIG. 4, observation of an appearance of the surface of the welding target material produced by the conventional welding method is hindered by reflection by a surrounding object, mirror reflection by a camera, and mirror reflection by illumination. On the other hand, the surface of the welding target material produced by the welding method in the present invention has no surface glossiness, and a clear edge can be confirmed.

In addition, when the pictures photographed by a laser measuring instrument in FIG. 4 are compared with each other, regarding the surface of the welding target material produced by the conventional welding method, the mirror-reflected portion cannot receive light and cannot be measured, so that data missing (dotted line portion) occurs. On the other hand, it can be seen that such data missing does not occur on the surface of the welding target material produced by the welding method in the present invention.

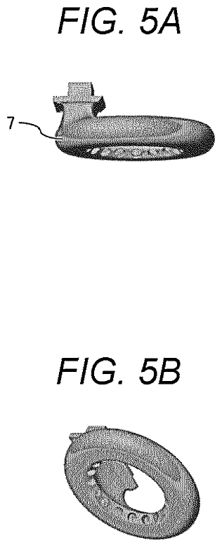

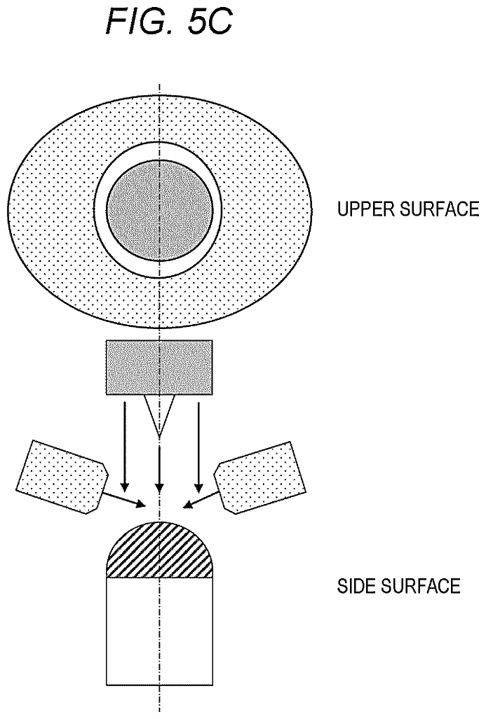

FIGS. 5A and 5B are perspective views showing a first example of the oxygen supply device used in the welding method in the present invention. FIG. 5C is a top view and a side view showing the first example of the oxygen supply device used in the welding method in the present invention. The oxygen supply device 5 may have, for example, a form having a plurality of gas blowout ports as shown in FIGS. 5A and 5B.

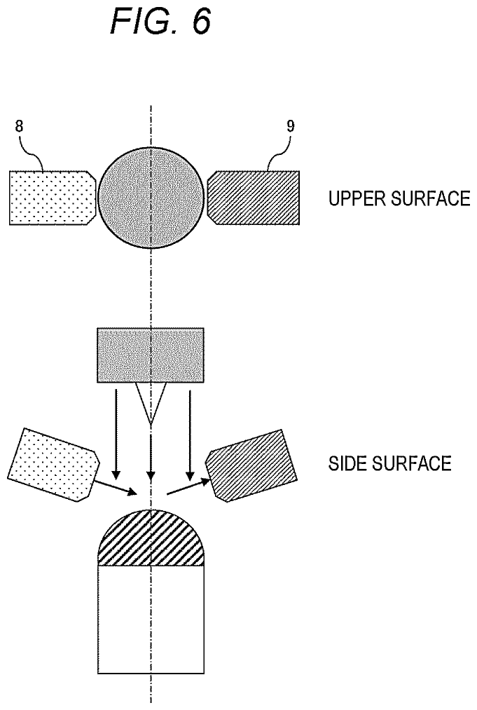

FIG. 6 is a top view and a side view showing a second example of the oxygen supply device used in the welding method in the present invention. The oxygen supply device shown in FIG. 6 includes an injection portion 8 that blows an oxygen-containing gas and a suction portion 9 that sucks the oxygen-containing gas. As described above, the oxygen supply device may be configured to recover the oxygen-containing gas. According to such a configuration, it is possible to easily control the supply amount of the oxygen-containing gas.

As described above, according to the present invention, it has been described that it is possible to provide the welding method of preventing specular reflection when the surface of the welding target material is photographed and suppressing the occurrence of porosity of the welding target material. Note that the present invention is not limited to the above-described embodiment, and various modifications are included. For example, the above-described embodiment has been described in detail for easy understanding of the present invention, and is not necessarily limited to those having all the described configurations. In addition, a portion of the configuration of a certain embodiment can be replaced with the configuration of another embodiment, and the configuration of another embodiment can be added to the configuration of a certain embodiment. In addition, a part of the configuration of each embodiment can be added, deleted, and replaced to, from, and with other configurations.

### REFERENCE SIGNS LIST

1 welding target material
2 torch
3 shielding gas
4 arc
5 oxygen supply device
6 oxygen-containing gas
7 molten portion of welding target material

1. A welding method comprising:
a melting step of melting a bonding portion of a welding target material by arc discharge while blowing an inert gas to the bonding portion; and
an oxidation step of oxidizing the bonding portion by supplying the inert gas and a gas containing oxygen to the bonding portion in a state where a portion of the melted bonding portion is solidified and the other portion is melted.

2. The welding method according to claim 1, wherein
a welding torch is installed to face a surface of the bonding portion of the welding target material,
in the melting step, the inert gas is supplied in a direction from the welding torch toward the welding target material, and melting of the bonding portion starts from the surface of the welding target material, and
in the oxidation step, at least the surface of the bonding portion facing the welding torch is oxidized.

3. The welding method according to claim 1, wherein the oxidation step is performed when a temperature of a surface of the welding target material is 400° C. or higher.

4. The welding method according to claim 1, wherein, in the melting step, two end portions of the welding target material are melted.

5. The welding method according to claim 4, wherein, in the oxidation step, when the two end portions of the welding target material are melted, the inert gas is removed to oxidize the end portions of the welding target material.
